(19) United States
(12) Patent Application Publication
(10) Pub. No.: US 2018/0273748 A1
(43) Pub. Date: Sep. 27, 2018

(54) INTERIOR/EXTERIOR MEMBER FOR AUTOMOBILE

(71) Applicant: MAZDA MOTOR CORPORATION, Hiroshima (JP)

(72) Inventors: Yohei ICHIHARA, Hiroshima-shi (JP); Haruo SASAKI, Yokkaichi-shi (JP)

(73) Assignee: MAZDA MOTOR CORPORATION, Hiroshima (JP)

(21) Appl. No.: 15/761,963

(22) PCT Filed: Jan. 13, 2017
(86) PCT No.: PCT/JP2017/001115

§ 371 Date: Mar. 21, 2018

(30) Foreign Application Priority Data
Jan. 26, 2016 (JP) 2016-012424

(51) Int. Cl. C08L 69/00; B60R 13/00; B29C 45/00

(52) U.S. Cl. CPC C08L 69/00; B60R 13/00; B29L 2031/30; C08L 2201/08; B29C 45/0001

(57) ABSTRACT

Provided is an automobile interior/exterior member including a thermoplastic resin compound containing, at a predetermined mixing ratio, a component (A) as polycarbonate resin which has a constitutional unit derived from a predetermined dihydroxy compound and a constitutional unit derived from predetermined cyclohexane dimethanol and whose content ratio of the constitutional unit derived from the predetermined dihydroxy compound and the constitutional unit derived from the predetermined cyclohexane dimethanol is 69/31 to 71/29 in units of molar ratio, a component (B) as butyl acrylate methyl methacrylate styrene-based rubber, a component (C) as dibutyl hydroxy toluene, a component (D) as a benzotriazole-based light stabilizer, and a component (E) as a hindered amine-based light stabilizer.

### TECHNICAL FIELD

The present invention relates to an automobile interior/exterior member including a thermoplastic resin composition containing polycarbonate resin, butyl acrylate methyl methacrylate styrene-based rubber, dibutyl hydroxy toluene, a benzotriazole-based light stabilizer, and a hindered amine-based light stabilizer.

### BACKGROUND ART

An aromatic polycarbonate resin has been broadly used as an engineering plastic with excellent thermal resistance, impact resistance, and transparency in various applications including automobiles and office automation equipment, among other things.

An aromatic polycarbonate resin is generally produced out of a raw material derived from petroleum resources. Recently, however, as concern about a possible depletion of such petroleum resources has been growing, there have been increasing demands for providing plastic molded products that use a raw material derived from a biomass resource such as a plant. In addition, in terms of reduction the amount of CO₂ gas, more and more people are waiting for development of plastic molded products made from a plant-derived monomer that can be carbon-neutral even when dumped after their use. The demand is particularly high in the field of large-sized molded products.

In such a situation, various polycarbonate resins made from a plant-derived monomer have been developed.

For example, it was proposed to obtain a polycarbonate resin by using isosorbide as a plant-derived monomer and producing a transesterification between isosorbide and diphenyl carbonate (see, for example, Patent Document 1). Also, a polycarbonate resin obtained by copolymerizing isosorbide bisphenol A was proposed as a copolymerized polycarbonate of isosorbide and other dihydroxy compounds (see, for example, Patent Document 2). Furthermore, an attempt was made to improve the stiffness of a homo-polycarbonate resin of isosorbide by copolymerizing isosorbide and aliphatic diol (see, for example, Patent Document 3).

Moreover, it is also described that a polycarbonate resin composition containing, in polycarbonate resin using isosorbide, elastomer as (meth)alkyl acrylate or butadiene as a core layer exhibits excellent transparency, weatherability, and impact resistance (see, e.g., Patent Documents 4 and 5).

### CITATION LIST

### Patent Documents

PATENT DOCUMENT 1: United Kingdom Patent No. 1079686

PATENT DOCUMENT 2: Japanese Unexamined Patent Publication No. S56-55425

PATENT DOCUMENT 3: WO 04/111106

PATENT DOCUMENT 4: WO 2012/132492

PATENT DOCUMENT 5: WO 2012/132493

### SUMMARY OF INVENTION

### Technical Problem

However, there have been increasing demands for automobile interior/exterior members with further improved light resistance, thermal resistance, and impact resistance. Thus, the molded products described in Patent Documents 4 and 5 are required to further improve their thermal resistance when used as automobile interior/exterior members.

An object of the present invention is to solve the above-described typical problem and provide an automobile interior/exterior member with excellent weatherability.

### Solution to the Problem

The present inventors carried out research and development to discover that a thermoplastic resin composition containing polycarbonate resin containing a constitutional unit derived from a predetermined dihydroxy compound with a particular site, butyl acrylate methyl methacrylate styrene-based rubber, dibutyl hydroxy toluene, a benzotriazole-based light stabilizer, and a hindered amine-based light stabilizer can solve the above-described problem, and a basic idea of the present invention has been acquired.

Specifically, the present invention consists in:

[1] An automobile interior/exterior member including

a thermoplastic resin compound containing components (A) to (E),

in which in the thermoplastic resin compound, the component (A) is 89 to 94 parts by mass, the component (B) is 6 to 11 parts by mass, the component (C) is 0.001 to 0.01 parts by mass, the component (D) is 0.08 to 0.12 parts by mass, and the component (E) is 0.04 to 0.06 parts by mass with respect to 100 parts by mass as a total of the component (A) and the component (B).

The component (A) is polycarbonate resin which has a constitutional unit derived from a dihydroxy compound expressed by the following general formula (1) and a constitutional unit derived from cyclohexane dimethanol and whose content ratio of the constitutional unit derived from the dihydroxy compound expressed by the following general formula (1) and the constitutional unit derived from the cyclohexane dimethanol is 69/31 to 71/29 in units of molar ratio.

The component (B) is butyl acrylate methyl methacrylate styrene-based rubber.

The component (C) is dibutyl hydroxy toluene.

The component (D) is a benzotriazole-based light stabilizer.

The component (E) is a hindered amine-based light stabilizer.

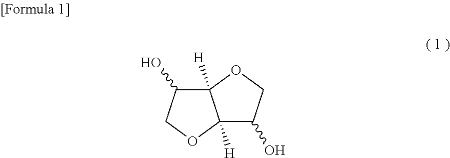

[2] The automobile interior/exterior member of [1], in which

the component (E) is a hindered amine-based light stabilizer with a piperidine structure.

[3] The automobile interior/exterior member of [2], in which

the component (E) is a hindered amine-based light stabilizer with a plurality of piperidine structures.

[4] The automobile interior/exterior member of [3], in which

the plurality of piperidine structures in the hindered amine-based light stabilizer are linked to a single alkane chain by ester binding.

[5] The automobile interior/exterior member of any one of [1] to [4], which is obtained by injection molding.

### Advantages of the Invention

According to the present invention, the particular thermoplastic resin composition is used, and therefore, the automobile interior/exterior member exhibiting excellent weatherability can be provided.

### DESCRIPTION OF EMBODIMENT

An embodiment of the present invention will be described below in detail. Note that the present invention is not limited to the following embodiment, and various modifications can be made without departing from the gist of the present invention.

This embodiment relates to an automotive interior/exterior member made of a thermoplastic resin composition containing a predetermined amount of a particular component.

[Thermoplastic Resin Composition]

The above-described thermoplastic resin composition is a composition containing, a predetermined amount for each component, particular polycarbonate resin (a component (A)), butyl acrylate methyl methacrylate styrene-based rubber (hereinafter sometimes referred to as “rubber of the present embodiment”) (a component (B)), dibutyl hydroxy toluene (a component (C)), a benzotriazole-based light stabilizer (a component (D)), and a hindered amine-based light stabilizer (a component (E)).

[Component (A) (Polycarbonate Resin Mixture)]

The polycarbonate resin as the component (A) is carbonate resin obtained by polymerization using, as a dihydroxy compound, at least a dihydroxy compound expressed by the following general formula (1) and cyclohexane dimethanol, and is also carbonate copolymer containing at least a constitutional unit (hereinafter sometimes referred to as a “constitutional unit (1)”) derived from the dihydroxy compound expressed by the following general formula (1) and a constitutional unit derived from cyclohexane dimethanol.

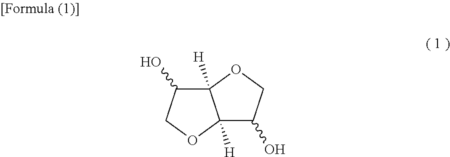

<Dihydroxy Compound Having Site Expressed by Formula (1)>

Examples of the dihydroxy compounds expressed by Formula (1) include isosorbide, isomannide, and isoidet, which are stereoisomers.

As for these dihydroxy compounds expressed by Formula (1), either a single dihydroxy compound may be used by itself or two or more dihydroxy compounds may be used in combination.

Among these dihydroxy compounds expressed by Formula (1), it is recommended to use isosorbide obtained by dehydration and condensation of sorbitol which is existent in profusion as a resource, easily available, and produced from various kinds of starch. The reason is that isosorbide is easily available and produced and has beneficial optical properties and moldability.

<Cyclohexane Dimethanol>

Specific examples of the cyclohexane dimethanol include 1,2-cyclohexane dimethanol, 1,3-cyclohexane dimethanol, and 1,4-cyclohexane dimethanol.

<Diester Carbonate>

The polycarbonate resin may be produced by a general polymerization method, which may be either interface polymerization using carbonyl chloride or melt polymerization that induces transesterification with respect to diester carbonate. It is recommended, however, to adopt the melt polymerization that allows the dihydroxy compound to react to diester carbonate having less toxicity to the environment under the presence of a polymerization catalyst.

In this case, the polycarbonate resin may be obtained by the melt polymerization that induces transesterification between dihydroxy compounds, including at least the dihydroxy compound expressed by the general formula (1) and cyclohexane dimethanol, and diester carbonate.

Diester carbonate to be used may generally be the compound expressed by the following Formula (2). Only one of these diester carbonate compounds may be used alone. Alternatively, two or more of the diester carbonate compounds may be mixed together.

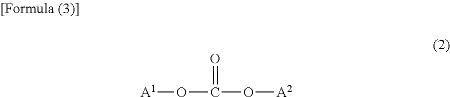

In Formula (2), A¹ and A² independently represent substituted or non-substituted aliphatic groups having a carbon number of 1 to 18 or substituted or non-substituted aromatic groups.

Examples of the diester carbonate expressed by Formula (2) include substituted diphenyl carbonates such as diphenyl carbonate and ditolyl carbonate, dimethyl carbonate, diethyl carbonate, and di-t-butyl carbonate. The diester carbonate is suitably a substituted diphenyl carbonate such as diphenyl carbonate, and more suitably diphenyl carbonate. The diester carbonate may include an impurity such as a chloride ion which may inhibit the polymerization reaction or deteriorate the hue of the resulting polycarbonate resin in some cases. Thus, the diester carbonate is suitably a refined (e.g., distilled) one depending on the necessity.

The diester carbonate is suitably used at a molar ratio of 0.90 to 1.20, more suitably at a molar ratio of 0.95 to 1.10, even more suitably at a molar ratio of 0.96 to 1.10, and particularly suitably at a molar ratio of 0.98 to 1.04, with respect to all dihydroxy compounds used for the melt polymerization.

If this molar ratio were less than 0.90, the number of terminal hydroxyl groups of the resultant polycarbonate resin would increase so much as to affect the thermal stability of the polymer, could make the thermoplastic resin composition being molded colored, could cause a decrease in transesterification rate, or could prevent the desired high molecular weight resin from being obtained.

However, if the molar ratio were greater than 1.20, then the transesterification rate would decrease too much under the same condition to produce the polycarbonate resin at a desired molecular weight easily. In addition, in that case, an increased amount of diester carbonate would remain in the polycarbonate resin produced to emit an odor either during the molding process or out of the molded product, which is not beneficial. This would increase the thermal history during the polymerization reaction so much that the resultant polycarbonate resin could have deteriorated hue or weatherability.

Furthermore, as the molar ratio of the diester carbonate with respect to all of the dihydroxy compounds increases, the amount of diester carbonate remaining in the resultant polycarbonate resin increases and may absorb an ultraviolet ray increasingly to deteriorate light resistance of the polycarbonate resin, which is not beneficial. According to the present embodiment, the concentration of the diester carbonate remaining in the polycarbonate resin is suitably 200 ppm by mass or less, more suitably 100 ppm by mass or less, even more suitably 60 ppm by mass or less, and particularly suitably 30 ppm by mass or less. Actually, however, a polycarbonate resin sometimes includes an unreacted diester carbonate. Such an unreacted diester carbonate in a polycarbonate resin ordinarily has a lower limit of 1 ppm by mass.

<Transesterification Catalyst>

A polycarbonate resin according to the present embodiment may be produced by causing transesterification between dihydroxy compounds including the constitutional unit (1) and the diester carbonate expressed by Formula (2) as described above. More specifically, the polycarbonate resin is obtained by causing the transesterification such that monohydroxy compounds produced as side products are removed out of the system. In this case, the melt polymerization is generally produced by causing the transesterification under the presence of a trans esterification catalyst.

Examples of the transesterification catalyst (hereinafter sometimes simply referred to as a “catalyst”) for use during the manufacturing process of the polycarbonate resin of the present embodiment include Group I metal compounds, Group II metal compounds, and various basic compounds such as basic boron compounds, basic phosphorus compounds, basic ammonium compounds, and amine-based compounds in the long periodic table (see Nomenclature of Inorganic Chemistry IUPAC Recommendations 2005). It is recommended that Group I metal compounds and/or Group II metal compounds be adopted, among these compounds.

Optionally, it is possible to use any suitable basic compound such as a basic boron compound, a basic phosphorus compound, a basic ammonium compound, or an amine based compound as a supplement to the Group I metal compound and/or Group II metal compound. Still, it is recommended that the Group I metal compound and/or the Group II metal compound be used alone.

Also, the Group I metal compound and/or Group II metal compound are/is normally used in the form of a hydroxide or a salt such as a carbonate, a carboxylate, or a phenolate. Considering their availability and the easiness of their handling, hydroxides, carbonates, and acetates are suitably adopted, and acetates are more suitably used in view of their hue and polymerization activity.

Examples of the Group I metal compounds include sodium hydroxide, potassium hydroxide, lithium hydroxide, cesium hydroxide, sodium hydrogen carbonate, potassium hydrogen carbonate, lithium hydrogen carbonate, cesium hydrogen carbonate, sodium carbonate, potassium carbonate, lithium carbonate, cesium carbonate, sodium acetate, potassium acetate, lithium acetate, cesium acetate, sodium stearate, potassium stearate, lithium stearate, cesium stearate, sodium borohydride, potassium borohydride, lithium borohydride, cesium borohydride, sodium tetraphenyl borate, potassium tetraphenyl borate, lithium tetraphenyl borate, cesium tetraphenyl borate, sodium benzoate, potassium benzoate, lithium benzoate, cesium benzoate, disodium hydrogen phosphate, dipotassium hydrogen phosphate, dilithium hydrogen phosphate, dicesium hydrogen phosphate, disodium phenyl phosphate, dipotassium phenyl phosphate, dilithium phenyl phosphate, dicesium phenyl phosphate, alcoholates and phenolates of sodium, potassium, lithium, and cesium, and disodium, dipotassium, dilithium and dicesium salts of bisphenol A. Among other things, cesium compounds and lithium compounds are suitably used.

Examples of the Group II metal compounds include calcium hydroxide, barium hydroxide, magnesium hydroxide, strontium hydroxide, calcium hydrogen carbonate, barium hydrogen carbonate, magnesium hydrogen carbonate, strontium hydrogen carbonate, calcium carbonate, barium carbonate, magnesium carbonate, strontium carbonate, calcium acetate, barium acetate, magnesium acetate, strontium acetate, calcium stearate, barium stearate, magnesium stearate, and strontium stearate. Among other things, magnesium compounds, calcium compounds, and barium compounds are suitably used, and magnesium compounds and/or calcium compounds are more suitably used.

Examples of the basic boron compounds include, sodium, potassium, lithium, calcium, barium, magnesium and strontium salts of tetramethylboron, tetraethylboron, tetrapropylboron, tetrabutylboron, trimethylethylboron, trimethylbenzylboron, trimethylphenylboron, triethylmethylboron, triethylbenzylboron, triethylphenylboron, tributylbenzylboron, tributylphenylboron, tetraphenylboron, benzyltriphenylboron, methyltriphenylboron and butyltriphenylboron.

Examples of the basic phosphorus compounds include triethylphosphine, tri-n-propylphosphine, triisopropylphosphine, tri-n-butylphosphine, triphenylphosphine, tributylphosphine, and a quaternary phosphonium salt.

Examples of the basic ammonium compounds include tetramethylammonium hydroxide, tetraethylammonium hydroxide, tetrapropylammonium hydroxide, tetrabutylammonium hydroxide, trimethylethylammonium hydroxide, trimethylbenzylammonium hydroxide, trimethylphenylammonium hydroxide, triethylmethylammonium hydroxide, triethylbenzylammonium hydroxide, triethylphenylammonium hydroxide, tributylbenzylammonium hydroxide, tributylphenylammonium hydroxide, tetraphenylammonium hydroxide, benzyltriphenylammonium hydroxide, methyltriphenylammonium hydroxide, and butyltriphenylammonium hydroxide.

Examples of the amine-based compounds include 4-aminopyridine, 2-aminopyridine, N,N-dimethyl-4-aminopyridine, 4-diethylaminopyridine, 2-hydroxypyridine, 2-methoxypyridine, 4-methoxypyridine, 2-dimethylaminoimidazole, 2-methoxyimidazole, imidazole, 2-mercaptoimidazole, 2-methylimidazole, and aminoquinoline.

Of these compounds, a least one metal compound selected from the group consisting of the Group II metal compounds and the lithium compounds is suitably used as the catalyst to obtain a polycarbonate resin with excellent physical properties in terms of transparency, hue and light resistance, for example.

Also, to allow the polycarbonate resin to have particularly good transparency, hue and light resistance, the catalyst is suitably at least one metal compound selected from the group consisting of magnesium compounds, calcium compounds, and barium compounds, more suitably at least one metal compound selected from the group consisting of magnesium compounds and calcium compounds.

If the catalyst used is a Group I metal compound and/or a Group II metal compound, the amount of the catalyst used and converted into the amount of the metal generally falls within the range of 0.1 to 300 μmol, suitably within the range of 0.1 to 100 μmol, more suitably within the range of 0.5 to 50 μmol, and particularly suitably within the range of 1 to 25 μmol, with respect to one mole of every dihydroxy compound used for reaction.

Among other things, if the catalyst used is a compound including at least one metal selected from the group consisting of the Group II metal compounds, the amount of the catalyst used and converted into the amount of the metal is suitably equal to or greater than 0.1 μmol, more suitably equal to or greater than 0.5 μmol, and even more suitably equal to or greater than 0.7 μmol, with respect to one mole of every dihydroxy compound used for reaction. Also, the upper limit is suitably 20 μmol, more suitably 10 μmol, even more suitably 3 μmol, and particularly suitably 2.0 μmol.

If the catalyst used were too little, the polymerization reaction would not be activated enough to produce a polycarbonate resin in a desired molecular weight or produce sufficient fracture energy. On the other hand, if the catalyst used were too much, not only the hue of the resulting polycarbonate resin would deteriorate but also some byproducts would be produced to cause a decrease in flowability and produce a gel more frequently. This may sometimes cause a brittle fracture and make it difficult to produce a polycarbonate resin of a target quality.

<Method of Producing Polycarbonate Resin>

The polycarbonate resin is obtained by melting and polymerizing together dihydroxy compounds, including the dihydroxy compound expressed by the general formula (1) and cyclohexane dimethanol, and a diester carbonate via transesterification. Note that the dihydroxy compound and the diester carbonate that are the materials of the polycarbonate resin are suitably mixed uniformly together before being subjected to the transesterification.

The temperature of the materials being mixed is generally at least equal to 80° C. and suitably 90° C. or more. The upper limit of the temperature is generally not greater than 250° C., suitably 200° C. or less, and more suitably 150° C. or less. Among other things, the temperature particularly suitably falls within the range of 100° C. to 120° C. If the mixing temperature were too low, then the rate of solution could be too low or the solubility could be insufficient, thus often resulting in solidification and other inconveniences. However, if the mixing temperature were too high, then the dihydroxy compound could be degraded thermally in some cases, and the resultant polycarbonate resin could have its hue deteriorated and its light resistance affected negatively.

Operation for mixing the dihydroxy compound and diester carbonate is performed under atmosphere with an oxygen concentration of 10% by volume or less, suitably 0.0001% by volume to 10% by volume, more suitably 0.001% by volume to 5% by volume, and much more suitably 0.0001% by volume to 1% by volume, considering prevention of hue deterioration of the resultant polycarbonate resin.

The polycarbonate resin is suitably produced by the melt polymerization in multiple stages under the presence of a catalyst by means of a plurality of reactors. A reason for performing the melt polymerization by the plurality of reactors is as follows: a large amount of monomer is contained in a reaction solution at an initial stage of melt polymerization reaction, and therefore, it is important to maintain a required polymerization speed while reducing monomer vaporization; balance shifts to a polymerization side at a late stage of the melt polymerization reaction, and therefore, it is important to sufficiently distil away a monohydroxy compound produced as a side product. Considering a production efficiency, the plurality of reactors arranged in series are suitably used for setting different polymerization reaction conditions. As described above, at least two or more reactors may be used. However, considering the production efficiency etc., the number of reactors is three or more, suitably three to five, and much more suitably four.

The type of the reaction may be any of a batch type, a continuous type, or a combination of the batch type and the continuous type.

Further, it is effective to use a reflux condenser as the polymerization reactor to reduce the amount of distillated monomer. Use of the reflux condenser is particularly effective in the reactor at an initial stage of polymerization in which there are a lot of unreacted monomer components. The temperature of refrigerant injected into the reflux condenser can be selected as necessary according to a monomer to be used. Normally, the temperature of refrigerant injected into the reflux condenser is, at an inlet of the reflux condenser, 45 to 180° C., suitably 80 to 150° C., and more suitably 100 to 130° C. An extremely-high temperature of refrigerant injected into the reflux condenser results in a smaller amount of reflux, and therefore, an effect is lowered. When the temperature is extremely low, the efficiency of distillation of a monohydroxy compound which should be distilled tends to decrease. Hot water, steam, heat carrier oil, etc. are used as the refrigerant, and steam and heat carrier oil are preferable.

To maintain an appropriate polymerization rate and to avoid a decline in the hue, thermal stability, light resistance, or any other property of the resultant polycarbonate resin while reducing the distillation of the monomer, it is meaningful to select an appropriate type of catalyst as the catalyst and use the catalyst in an appropriate amount.

If two or more of the reactors are used to produce the polycarbonate resin, multiple reaction stages to be carried out under different conditions may be defined, or the temperature and/or pressure may be changed continuously, in those reactors.

While the polycarbonate resin is being produced, the catalyst may be either added to the material preparing vessel or material reservoir or added directly to the reactors. From the standpoints of the stability of supply and control of the melt polymerization, a catalyst supply line may be disposed halfway through a line of the materials yet to be supplied to the reactors, and the materials are suitably supplied in the form of an aqueous solution.

Regarding polymerization conditions, in an initial stage of the polymerization, the polymerization is suitably conducted at a relatively low temperature and under a relatively low vacuum to obtain a prepolymer. Meanwhile, in a late stage of the polymerization, the polymerization is suitably conducted at a relatively high temperature and under a relatively high vacuum to raise the molecular weight to a predetermined value. It is, however, beneficial from the standpoints of hue and light resistance of the polycarbonate resin to be obtained that a jacket temperature, an internal temperature, and an internal pressure of a reaction system are appropriately selected at each molecular-weight stage. For example, if either the temperature or the pressure were changed too quickly before the polymerization reaction reaches a predetermined value, an unreacted monomer would be distilled off to alter the molar ratio of the dihydroxy compounds to the diester carbonate. This could result in a decrease in polymerization rate or make it impossible to obtain a polymer having a predetermined molecular weight or intended terminal groups, thus possibly hampering advantageous effects of the present embodiment from being achieved.

The transesterification temperature should not be too low, because such a temperature would lead to a decline in productivity and an increase in the thermal history of the product. Nevertheless, the transesterification temperature should not be too high, either, because such a temperature would not only cause the vaporization of the monomer but also promote the decomposition and coloring of the polycarbonate resin as well.

In producing the polycarbonate resin, the method of causing the transesterification between dihydroxy compounds, including the dihydroxy compound expressed by the general formula (1) and cyclohexane dimethanol, and diester carbonate under the presence of a catalyst is generally carried out as a multi-stage process consisting of two or more stages. Specifically, a first-stage transesterification temperature (in the present specification, sometimes referred to as an “internal temperature”) may be suitably 140° C. or higher, more suitably 150° C. or higher, much more suitably 180° C. or higher, and still much more suitably 200° C. or higher. Moreover, the first-stage transesterification temperature may be suitably 270° C. or lower, more suitably 240° C. or lower, much more suitably 230° C. or lower, and still much more suitably 220° C. or lower. A residence time at the first transesterification stage is normally 0.1 to 10 hours, and suitably 0.5 to 3 hours. The first transesterification stage is performed while the resultant monohydroxy compound is being distilled away to the outside of the reaction system. After a second stage, the transesterification temperature is increased, and the transesterification is normally performed at a temperature of 210 to 270° C., and suitably 220 to 250° C. Then, while the monohydroxy compound generated at the same time is being removed to the outside of the reaction system, the pressure of the reaction system is gradually decreased from a first-stage pressure. Eventually, the pressure of the reaction system is decreased to 200 Pa or lower. Normally, polycondensation reaction is performed for 0.1 to 10 hours, suitably 0.5 to 6 hours, and more suitably 1 to 3 hours.

If the transesterification temperature were excessively high, the hue would deteriorate when the materials are formed into a molded product, thus possibly increasing the chances of brittle fracture. However, if the transesterification temperature were too low, then the target molecular weight could not rise, the molecular weight distribution could become too broad, and the impact resistance could be insufficient in some cases. Furthermore, if the residence time of the transesterification were too long, then the brittle fracture ratio could tend to increase in some cases. Meanwhile, if the residence time were too short, then the target molecular weight could not rise and the impact resistance could be insufficient in some cases.

Considering effective resource utilization, the monohydroxy compound produced as the side product is suitably refined as necessary, and then, is suitably re-utilized as a material of diester carbonate and various bisphenol compounds.

Particularly, to obtain a good polycarbonate resin having a high impact strength with the coloring, thermal degradation or scorching thereof minimized, the maximum internal temperature in the reactors on every reaction stage is suitably lower than 255° C., more suitably 250° C. or less, and particularly falls within the range of 225 to 245° C. To prevent the polymerization rate from dropping significantly during the second half of the polymerization reaction and to minimize the thermal degradation of the polycarbonate resin due to the thermal history, a horizontal reactor having good plug flowability and surface renewability is suitably used during the last stage of the reaction.

For the purpose of obtaining high impact resistance polycarbonate resin, polymerization temperature and time are sometimes increased as much as possible to obtain polycarbonate resin with a great molecular amount. In this case, brittle fracture tends to occur due to a foreign substance or scorching in the polycarbonate resin. For this reason, for satisfying both of impact strength enhancement and brittle fracture reduction, the polymerization temperature is suitably suppressed, and for shortening the polymerization time, use of a high-active catalyst and proper adjustment of a pressure setting etc. of the reaction system are suitably performed. Further, in the middle of reaction or at a final stage of reaction, a foreign substance or scorching caused in the reaction system is suitably removed by a filter etc. to reduce brittle fracture.

Note that in the case of producing the polycarbonate resin using, as the diester carbonate expressed by Formula (2), substituted diphenyl carbonate such as diphenyl carbonate and ditolyl carbonate, phenol or substituted phenol is produced as a side product, and it is inevitable that such a side product remains in the polycarbonate resin. These types of phenol and substituted phenol also have an aromatic ring. For this reason, phenol and substituted phenol absorb an ultraviolet ray, leading not only to deterioration of light resistance but also to odor emission upon molding. The polycarbonate resin contains, after normal batch reaction, an aromatic monohydroxy compound having an aromatic ring, such as a phenol by-product, of 1000 ppm by mass or greater. However, considering light resistance and odor reduction, a horizontal reactor with excellent devolatilization performance or an extruder with a vacuum vent is used to suitably bring the content of the aromatic monohydroxy compound in the polycarbonate resin into 700 ppm by mass or less, more suitably 500 ppm by mass or less, and much more suitably 300 ppm by mass or less. Note that it is difficult to industrially fully remove the aromatic monohydroxy compound, and therefore, the lower limit of the content of the aromatic monohydroxy compound in the polycarbonate resin is normally 1 ppm by mass. Note that these aromatic monohydroxy compounds may, needless to say, have substituted groups depending on a material to be used. For example, the aromatic monohydroxy compound may have an alkyl group having a carbon number of 5 or less.

Also, Group I metals such as lithium, sodium, potassium or cesium, particularly, sodium, potassium, or cesium, among other things, may enter the polycarbonate resin from not only the catalyst used but also the raw materials or the reactors in some cases. Considering that these metals could affect the hue negatively when included a lot in the polycarbonate resin, the total content of these compounds in the polycarbonate resin of the present embodiment is suitably as small as possible. Thus, the content of these metals in the polycarbonate resin is generally not greater than 1 ppm by mass, suitably 0.8 ppm by mass or less, and more suitably 0.7 ppm by mass or less.

The content of the metals in the polycarbonate resin may be measured by any of various known methods. For example, after the metals in the polycarbonate resin have been recovered by a technique such as wet ashing, the content of the metals may be measured by a technique such as atomic emission, atomic absorption, or inductively coupled plasma (ICP) spectroscopy.

After having been subjected to the melt polymerization as described above, the polycarbonate resin of the present embodiment is usually cooled and solidified, and then pelleted with a rotary cutter, for example.

Any arbitrary pelleting method may be adopted. For example, any of the following methods may be used. Specifically, the polycarbonate resin in a molten state may be removed from the last polymerization reactor, and then cooled and solidified in the form of strands such that the polycarbonate resin thus solidified is pelleted. Alternatively, the resin in a molten state may be supplied from the last polymerization reactor to a uniaxial or biaxial extruder so as to be extruded in the molten state, and then cooled and solidified such that the polycarbonate resin thus solidified is pelleted. Still alternatively, the polycarbonate resin in a molten state may be removed from the last polymerization reactor, and cooled and solidified in the form of strands such that the polycarbonate resin thus solidified is pelleted once. After that, the resin may be supplied again to a uniaxial or biaxial extruder, extruded in a molten state, and then cooled and solidified such that the polycarbonate resin thus solidified is pelleted.

During this process, in the extruder, the monomer remaining there may be devolatilized under a reduced pressure, and/or any agent selected from the group consisting of generally known thermal stabilizers, neutralizers, ultraviolet absorbers, mold release agents, colorants, antistatic agents, slip additives, lubricants, plasticizers, compatibilizers, and flame retardants may also be added and kneaded together.

The temperature of the melt kneading process to be performed in the extruder varies depending on the glass transition temperature and molecular weight of the polycarbonate resin, but normally falls within the range of 150 to 300° C., suitably within the range of 200 to 270° C., and more suitably within the range of 230 to 260° C. If the melt kneading temperature were lower than 150° C., then the polycarbonate resin would have so high melt viscosity as to impose too heavy load on the extruder to avoid a decline in productivity. However, if the melt kneading temperature were higher than 300° C., then the polycarbonate would be thermally degraded so significantly that its mechanical strength would decrease due to a decline in its molecular weight, the resin would be colored or emit a gas, foreign substances would enter the resin, or the resin would get scorched. Thus, to eliminate such foreign substances or scorching, it is recommended that a filter be disposed either in the extruder or at the outlet of the extruder.

The size (the opening side) of the above-described filter for foreign substance removal is, with a goal for a filtration accuracy for removing 99% of foreign substances, normally 400 μm or less, suitably 200 μm or less, and more suitably 100 μm or less. An excessively-large opening side of the filter might result in insufficient removal of foreign substances or scorching. In the case of molding the polycarbonate resin, brittle fracture might occur. Moreover, the opening size of the above-described filter can be adjusted according to an application of the thermoplastic resin composition of the present embodiment. For example, in the case of an application for a film, the opening size of the above-described filter is, due to a demand for defect elimination, suitably 40 μm or less, and more suitably 10 μm or less.

Further, multiple filters described above may be used in series, or a filtration device configured such that multiple leaf disk polymer filters are stacked on each other may be used.

When the molten extruded polycarbonate resin is cooled for pelleting, a cooling method such as air cooling or water cooling is suitably used. Air from which foreign substances have been removed in advance by a HEPA filter (suitably a filter specified according to JIS Z8112) is suitably used as air used for air cooling, thereby preventing re-adherence of the foreign substances in the air. Such cooling is suitably performed in a clean room of a class 7 defines according to JIS B 9920 (in 2002), and more suitably a clean room with a cleanness of a class 6 or higher. When water cooling is used, water from which a metal content is removed by ion-exchange resin and foreign substances are further removed by a filter is suitably used. There are various opening sizes of the filter to be used, but a filter with 10 to 0.45 μm is suitable.

When the polycarbonate resin of the present embodiment is produced by the melt polymerization, one or more types of a phosphorous or phosphoric acid compound may be added upon polymerization for the purpose of preventing coloring.

As the phosphoric acid compound, one or more types of trialkyl phosphate such as trimethyl phosphate and triethyl phosphate are suitably used. These compounds added suitably account for 0.0001 mol % to 0.005 mol % and more suitably 0.0003 mol % to 0.003 mol % with respect to all hydroxy compound components contributing to reaction. If the phosphorus compounds added were below the lower limit, the coloring phenomenon would be reduced much less effectively. However, if the phosphorus compounds added were above the upper limit, then the transparency would decrease, the coloring phenomenon would rather be promoted, or the thermal resistance would decline.

As the phosphorous acid compound, any one or more thermal stabilizers may be selectively used from the group consisting of trimethyl phosphite, triethyl phosphite, tris(nonylphenyl) phosphite, trimethyl phosphate, tris(2,4-di-tert-butylphenyl) phosphite, and bis(2,4-di-tert-butylphenyl) pentaerythritol diphosphite. These phosphorous acid compounds added suitably account for 0.0001 mol % to 0.005 mol % and more suitably 0.0003 mol % to 0.003 mol % with respect to all hydroxy compounds contributing to reaction. If the phosphorous acid compounds added were below the lower limit, the coloring phenomenon would be reduced much less effectively. However, if the phosphorous acid compounds added were above the upper limit, then the transparency would decrease, the coloring phenomenon would rather be promoted, or the thermal resistance would decline.

The phosphoric acid compound and the phosphorous acid compound may be added in combination. In that case, the amount added is the sum of the amounts of the phosphoric acid and phosphorous acid compounds added, and is also suitably in the range of 0.0001 mol % to 0.005 mol % and more suitably 0.0003 mol % to 0.003 mol % with respect to all hydroxy compounds contributing to reaction. If their amount added were below the lower limit, the coloring phenomenon would be reduced much less effectively. However, if their amount added were above the upper limit, then the transparency would decrease, the coloring phenomenon would rather be promoted, or the thermal resistance would decline.

Also, one or more thermal stabilizers may be added to the polycarbonate resin thus produced in order to substantially avoid a decline in the molecular weight during the molding process and deteriorated hue.

As such a thermal stabilizer, any of phosphorous acid, phosphoric acid, phosphonous acid, phosphonic acid, or their esters may be used. Specific examples of the thermal stabilizer include triphenyl phosphite, tris(nonylphenyl) phosphite, tris(2,4-di-tert-butylphenyl) phosphite, tridecyl phosphite, trioctyl phosphite, trioctadecyl phosphite, didecyl monophenyl phosphite, dioctyl monophenyl phosphite, diisopropyl monophenyl phosphite, monobutyl diphenyl phosphite, monodecyl diphenyl phosphite, monooctyl diphenyl phosphite, bis(2,6-di-tert-butyl-4-methylphenyl) pentaerythritol diphosphite, 2,2-methylene bis(4,6-di-tert-butylphenyl) octyl phosphite, bis(nonylphenyl) pentaerythritol diphosphite, bis(2,4-di-tert-butylphenyl) pentaerythritol diphosphite, distearyl pentaerythritol diphosphite, tributyl phosphate, triethyl phosphate, trimethyl phosphate, triphenyl phosphate, diphenyl monoorthoxenyl phosphate, dibutyl phosphate, dioctyl phosphate, diisopropyl phosphate, 4,4′-biphenylene diphosphinate tetrakis (2,4-di-tert-butylphenyl), dimethyl benzene phosphonate, diethyl benzene phosphonate, and dipropyl benzene phosphonate. Among other things, tris(nonylphenyl) phosphite, trimethyl phosphate, tris(2,4-di-tert-butylphenyl) phosphite, bis(2,4-di-tert-butyl-phenyl) pentaerythritol diphosphite, bis(2,6-di-tert-butyl-4-methylphenyl) pentaerythritol diphosphite, and dimethyl benzene phosphonate are suitably used.

An amount of the thermal stabilizer may be further added even after the thermal stabilizer has been added during the melt polymerization. Specifically, a phosphorous acid compound may be mixed by the mixing method to be described later after a polycarbonate resin has been obtained with an appropriate amount of a phosphorous or phosphoric acid compound added. This allows addition of an even larger amount of the thermal stabilizer with a decrease in transparency or thermal resistance minimized and with coloring avoided during the polymerization, thus substantially preventing the hue from deteriorating.

The content of any of these thermal stabilizers relative to 100 parts by mass of the polycarbonate resin is suitably in the range of 0.0001 to 1.0 part by mass, more suitably in the range of 0.0005 to 0.5 parts by mass, and even more suitably in the range of 0.001 to 0.2 parts by mass.

<Physical Properties of Polycarbonate Resin>

The physical properties that the polycarbonate resin of the present embodiment suitably has will be described below.

(Glass Transition Temperature)

The polycarbonate resin of the present embodiment has a glass transition temperature (Tg) of less than 145° C. If the glass transition temperature of the polycarbonate resin were over this range, then the polycarbonate resin would be colored easily and it could be difficult to increase its impact resistance. Also, in that case, the temperature of a die should be set to be high when the surface shape of the die is transferred onto the molded product during the molding process. This might limit the types of usable temperature controllers or could deteriorate the transferability of the die surface shape.

The polycarbonate resin of the present embodiment suitably has a glass transition temperature of less than 140° C., and more suitably less than 135° C.

Furthermore, the glass transition temperature of the polycarbonate resin according to the present embodiment is generally at least equal to 90° C., and suitably equal to or higher than 95° C.

Examples of techniques for making the glass transition temperature of the polycarbonate resin according to the present embodiment less than 145° C. include decreasing the ratio of the constitutional unit (1) in the polycarbonate resin, selecting an alicyclic dihydroxy compound with low thermal resistance as the dihydroxy compound for use to produce the polycarbonate resin, and decreasing the ratio of the constitutional unit derived from an aromatic dihydroxy compound such as a bisphenol compound in the polycarbonate resin.

Note that the glass transition temperature of the polycarbonate resin according to the present embodiment was measured by the method to be described later for the examples.

(Reduced Viscosity)

The degree of polymerization of the polycarbonate resin of the present embodiment may be represented as a reduced viscosity to be measured at a temperature of 30.0° C.±0.1° C. (hereinafter sometimes simply referred to as “reduced viscosity”) by precisely adjusting the concentration of the polycarbonate resin to 1.00 g/dl using, as a solvent, a mixed solvent in which phenol and 1,1,2,2-tetrachloroethane are mixed together at a mass ratio of one to one. The reduced viscosity is suitably at least equal to 0.40 dl/g, more suitably equal to or greater than 0.42 dl/g, and particularly suitably equal to or greater than 0.45 dl/g. Depending on its application, the thermoplastic resin composition of the present embodiment suitably has a reduced viscosity of at least 0.60 dl/g, or even equal to or greater than 0.85 dl/g. Meanwhile, the reduced viscosity of the polycarbonate resin according to the present embodiment is suitably not greater than 2.0 dl/g, more suitably equal to or less than 1.7 dl/g, and particularly suitably equal to or less than 1.4 dl/g. If the polycarbonate resin had too low a reduced viscosity, then the polycarbonate resin could sometimes have significantly decreased mechanical strength. Meanwhile, if the polycarbonate resin had too high a reduced viscosity, then the polycarbonate resin would have a decreased degree of flowability and deteriorated cycle characteristic during the molding process and would tend to increase the strain of, and more easily thermally deform, the molded product.

[Mixing Polycarbonate Resins]

The component (A) of the present embodiment is a molten mixture of a plurality of carbonate copolymers having respectively different copolymerization ratios. The temperature of this molten mixture (represented as the temperature of the resin measured at the melt extruding port) may fall within the range of 235° C. to 245° C., and suitably falls within the range of 238° C. to 242° C. Setting the temperature of the molten mixture within either of these ranges allows for reducing coloring, thermal degradation, or scorching of the polycarbonate resins, thus providing a mixture of good polycarbonate resins with high impact resistance.

The range of the respectively different copolymerization ratios of the carbonate copolymers and the mixing ratio of the plurality of polycarbonate copolymers are appropriately selected such that the copolymerization ratio (the content ratio) of the polycarbonate resin mixture obtained by the mixing process falls within a predetermined range. As the copolymerization ratio of the polycarbonate resin mixture obtained by the mixing process, the ratio of the mole number of the constitutional unit (1) to the total mole number of the constitutional unit (1) and the constitutional unit derived from cyclohexane dimethanol is equal to or greater than 69 mol %, and suitably equal to or greater than 69.5 mol %. Furthermore, its upper limit is not greater than 71 mol % and suitably equal to or less than 70.5 mol %. Also, the ratio of the mole number of the constitutional unit derived from cyclohexane dimethanol to the total mole number mentioned above is not less than 29 mol %, and suitably equal to or greater than 29.5 mol %. Furthermore, its upper limit is not greater than 31 mol % and suitably equal to or less than 30.5 mol %.

If the ratio of the mole number of the constitutional unit (1) to the total mole number were less than the above-described ratio (i.e., if the ratio of the mole number of the constitutional unit derived from cyclohexane dimethanol to the total mole number were greater than the above-described ratio), then the thermal resistance could decline, which is a problem. If the ratio of the mole number of the constitutional unit (1) to the total mole number were greater than the above-described ratio (i.e., if the ratio of the mole number of the constitutional unit derived from cyclohexane dimethanol to the total mole number were less than the above-described ratio), then the impact resistance could decline, which is a problem.

Note that the content of the component (A) when the total of the component (A) and the component (B) is 100 parts by mass in the thermoplastic resin composition is 89 parts by mass or greater, and suitably 89.5 parts by mass or greater. With a content less than the above-described value, a problem leading to lowering of thermal resistance might be caused. On the other hand, the upper limit of the content of the component (A) is 94 parts by mass or less, and suitably 93.5 parts by mass. With a content greater than the above-described value, a problem leading to lowering of impact resistance might be caused.

[Component (B) (Butyl Acrylate Methyl Methacrylate Styrene-Based Rubber) (Rubber of the Present Embodiment)]

In the thermoplastic resin composition of the present embodiment, the polycarbonate resin mixture as the component (A) contains, as the component (B), butyl acrylate methyl methacrylate styrene-based rubber (the rubber of the present embodiment).

Note that core-shell graft copolymer obtained by graft copolymerization using a polymer component called a “rubber component” as a core layer and a monomer component copolymerizable with the polymer component as a shell layer is normally suitable as the rubber of the present embodiment.

The method for producing the core-shell graft copolymer may include any of production methods such as bulk polymerization, solution polymerization, suspension polymerization, and emulsion polymerization, and a copolymerization method may be single-stage grafting or multi-stage grafting. Note that in the present embodiment, the rubber of the present embodiment available in the market can be normally used as it is. Examples of the rubber of the present embodiment available in the market include, but not be limited to, the following rubbers.

The examples include a product name of Kane Ace M-590 manufactured by Kaneka Corporation, a product name of Metablen W-341 and W-377 manufactured by Mitsubishi Rayon Co., Ltd., and a product name of Acrypet IR377, IR441, IR491 manufactured by Mitsubishi Rayon Co., Ltd. Of these examples, a product name of Kane Ace M-590 manufactured by Kaneka Corporation is most suitable because of a high refraction index and high thermal resistance.

The monomer component as the shell layer graft-copolymerizable with the polymer component of the core layer is a (meth)acrylic acid ester compound.

Specific examples of the (meth)acrylic acid ester compound include alkyl (meth)acrylate such as methyl (meth)acrylate, ethyl (meth)acrylate, butyl (meth)acrylate, cyclohexyl (meth)acrylate, and octyl (meth)acrylate. Of these examples, easily-available methyl (meth)acrylate and ethyl (meth)acrylate are suitable, and methyl (meth)acrylate is more suitable. The “(meth)acrylate” is a collective term of “acrylic” and “methacryl.”

The core-shell graft copolymer suitably contains a butyl acrylate-styrene copolymer component of 40% by mass or more, and more suitably 60% by mass or more. Moreover, a (meth)acrylic acid ester component of 10% by mass or more is suitably contained.

In the core-shell graft copolymer, a portion of the “butyl acrylate-styrene copolymer” corresponds to the core layer.

The rubber of the present embodiment such as the core-shell graft copolymer may be used by itself or two or more rubbers may be used in combination.

The content of the component (B) is 6 parts by mass or greater with respect to 100 parts by mass as the total of the component (A) and the component (B), suitably 6.5 parts by mass or greater, and more suitably 7 parts by mass or greater. Upon mixing of a content equal to or greater than the above-described content, such a content is suitable because surface impact resistance and an impact resistance improvement effect are improved. On the other hand, the upper limit of the content of the component (B) is 11 parts by mass or less, suitably 10.5 parts by mass or less, and more suitably 10.2 parts by mass or less. A content equal to or less than the above-described content is suitable considering an outer appearance and thermal resistance of a molded product as the automobile interior/exterior member of the present embodiment.

[Method for Producing Thermoplastic Resin Composition]

The thermoplastic resin composition can be produced in such a manner that the polycarbonate resin mixture as the component (A), the rubber of the present embodiment as the component (B), and later-described additives are melted and mixed.

Specifically, the pelleted component (A), the component (B), and the various other components may be blended together with an extruder, extruded in the form of strands, and then cut into pellets with a rotary cutter, for example, to obtain the thermoplastic resin composition of the present embodiment.

<Additives>

Upon mixing of the component (A) and the component (B), the following additives can be added and mixed.

[Component (C) (Dibutyl Hydroxy Toluene)]

The thermoplastic resin composition according to the present embodiment includes, as the component (C), dibutyl hydroxy toluene. Adding this component allows for curbing a decline in the molecular weight during a weatherability test (i.e., improving the weatherability).

The content of the component (C) may be 0.001 parts by mass or greater, and suitably 0.002 parts by mass or greater with respect to 100 parts by mass as the total of the component (A) and the component (B). With a content equal to or less than the above-described value, the decline in the molecular weight during the weatherability test is not be curbed sufficiently effectively. On the other hand, the upper limit of the content of the component (C) is 0.01 parts by mass or less, and suitably 0.008 parts by mass or less. With a content equal to or greater than the above-described value, substances deposited on the die increase.

[Component (D) (Benzotriazole-Based Light Stabilizer)]

The thermoplastic resin composition according to the present embodiment includes, as the component (D), a benzotriazole-based light stabilizer. Adding this component allows for curbing a decline in the molecular weight during the weatherability test.

Specific examples of the benzotriazole-based light stabilizer include 2-(2′-hydroxy-3′-methyl-5′-hexylphenyl)benzotriazole, 2-(2′-hydroxy-3′-t-butyl-5′-hexylphenyl)benzotriazole, 2-(2′-hydroxy-3′,5′-di-t-butylphenyl)benzotriazole, 2-(2′-hydroxy-3′-methyl-5′-t-octylphenyl)benzotriazole, 2-(2′-hydroxy-5′-t-dodecylphenyl)benzotriazole, 2-(2′-hydroxy-3′-methyl-5′-t-dodecylphenyl)benzotriazole, 2-(2′-hydroxy-5′-t-butylphenyl)benzotriazole, and methyl-3-(3-(2H-benzotriazole-2-yl)-5-t-butyl-4-hydroxyphenyl)propionate.

The content of the component (D) is 0.08 parts by mass or greater, and suitably 0.09 parts by mass or greater with respect to 100 parts by mass as the total of the component (A) and the component (B). If the content were less than 0.08 parts by mass, the discoloration of the coloring agent would not be prevented sufficiently effectively. On the other hand, the upper limit of the content of the component (D) is 0.12 parts by mass or less, and suitably 0.11 parts by mass. If the content were greater than 0.12 parts by mass, substances deposited on the die would increase.

[Component (E) (Hindered Amine-Based Light Stabilizer)]

The thermoplastic resin composition according to the present embodiment includes, as the component (E), a hindered amine-based light stabilizer. Adding this component allows for curbing a decline in the molecular weight during the weatherability test.

The hindered amine-based light stabilizer has a structure in which nitrogen forms part of a cyclic structure, and more suitably has a piperidine structure. The piperidine structure defined herein may be any structure as long as the structure has a saturated six-membered ring amine structure, and includes a piperidine structure partially replaced with a substituent group. The substituent group that the piperidine structure may have may be an alkyl group having a carbon number of 4 or less, and is suitably a methyl group, in particular. Furthermore, the amine compound is suitably a compound having a plurality of piperidine structures. In the case of having the plurality of piperidine structures, those piperidine structures are suitably linked to a single alkane chain by ester binding. A specific example of such a hindered amine-based light stabilizer may be a compound expressed by the following Formula (3):

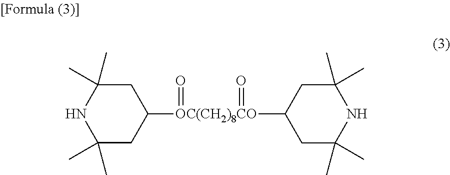

The content of the component (E) is 0.04 parts by mass or greater, and suitably 0.045 parts by mass or greater with respect to 100 parts by mass as the total of the component (A) and the component (B). If the content were less than 0.04 parts by mass, the discoloration of the coloring agent would not be prevented sufficiently effectively. On the other hand, the upper limit of the content of the component (E) is 0.06 parts by mass or less, and suitably 0.055 parts by mass or less. If the content were greater than 0.06 parts by mass, substances deposited on the die would increase.

<Mixing Method>

The components (A) to (E) described above may be blended together by a method in which they are mixed and kneaded together with a tumbler, a V-blender, a super mixer, a Nauta mixer, a Banbury mixer, a kneading roll, or an extruder. Alternatively, the method includes a solution blending method in which they are mixed together while being dissolved in a common good solvent such as methylene chloride. However, the method for mixing the above-described components (A) to (E) is not limited to any particular blending method, but any of various general blending methods may be adopted arbitrarily.

The thermoplastic resin composition thus obtained according to the present embodiment may be molded into a desired shape in the following manner Specifically, the respective components may be mixed together, and then the mixture is once pelleted either directly or through a melt extruder. After that, the pellets thus obtained may be molded by a generally known forming process such as extrusion, injection molding, or compression.

[Thermoplastic Resin Molded Product]

Molding the thermoplastic resin composition of the present embodiment allows an automobile interior/exterior member according to the present embodiment to be obtained.

The automobile interior/exterior member of the present embodiment is suitably molded by an injection molding process.

In that case, the automobile interior/exterior member of the present embodiment can be molded into a complex shape.

### EXAMPLES

Next, the present embodiment will be described in further detail by way of illustrative examples. Note that the present embodiment is in no way limited to the following examples. First of all, an evaluation method will be described.

<Evaluation Method>

(1) Measurement of Deflection Temperature Under Load

A pellet of a thermoplastic resin composition was dried at 90° C. for six hours with a hot air drier. Next, the pellet of the polycarbonate copolymer or resin composition thus dried was supplied to an injection molding machine (J75EII manufactured by the Japan Steel Works, Ltd.), thereby forming an ISO test piece to evaluate its mechanical and physical properties at a resin temperature of 240° C., a die temperature of 60° C., and a molding cycle time of 40 seconds. Then, the ISO test piece to evaluate the mechanical and physical properties thus obtained had its deflection temperature under load measured under a load of 1.80 MPa by a method compliant with the IS075 standard.

(2) Measurement of Charpy Impact Strength

The ISO test piece to evaluate the mechanical and physical properties obtained as described above was subjected to a notched Charpy impact test in compliance with the ISO 179 (in 2000). The higher this value is, the higher the impact resistance should be.

(3) Comprehensive Judgment

A thermoplastic resin composition with a deflection temperature under load of not less than 95° C. and a Charpy impact strength of 20 kJ/m² or higher was judged to be good (a white circle). Otherwise, the resin composition was judged to be poor (a cross mark).

<Raw Materials>

(Material for Polycarbonate Resin Mixture (Component (A)))

ISB: isosorbide (POLYSORB manufactured by Rocket Frères Sa.)
CHDM: cyclohexane dimethanol (manufactured by Eastman Chemical Company)
DPC: diphenyl carbonate (manufactured by Mitsubishi Chemical Corporation)
Calcium Acetate: calcium acetate monohydrate (manufactured by Wako Pure Chemical Industries, Ltd.)

<Butyl Acrylate Methyl Methacrylate Styrene-Based Rubber (Component (B))>

M-590: butyl acrylate methyl methacrylate styrene-based rubber (Kane Ace M-590 manufactured by Kaneka Corporation)

<Phenol-Based Antioxidant (Component (C))>

BHT: dibutyl hydroxy toluene (YOSHINOX BHT manufactured by API Corporation)

<Light Stabilizer>

(Component (D))

TINUVIN329: benzotriazole-based UVA (TINUVIN329 manufactured by BASF)

(Component (E))

TINUVIN770DF: HALS (TINUVIN770DF manufactured by BASF and expression by the following formula (3))

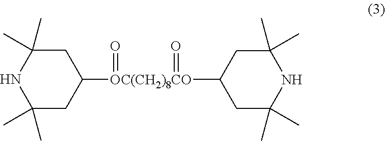

### First Manufacturing Example

In a polymerization reactor including an impeller and a reflux condenser controlled at 100° C., prepared were ISB, CHDM, DPC that had been distilled and refined to have an ion chloride concentration of 10 ppb or less, and calcium acetate monohydrate such that these compounds would satisfy the molar ratio ISB/CHDM/DPC/calcium acetate monohydrate=0.70/0.30/1.00/1.3×10⁻⁶. These compounds were sufficiently replaced with nitrogen to have their oxygen concentration adjusted to the range of 0.0005 to 0.001 vol %. Next, these compounds were heated with a heating medium. When their inner temperature reached 100° C., they started to be stirred up such that the content would be melted and mixed uniformly while being controlled to keep an inner temperature of 100° C. Thereafter, the temperature started to be raised such that the inner temperature would reach 210° C. in 40 minutes. When the inner temperature reached 210° C., the pressure started to be reduced with control still carried on to keep this temperature. The pressure was reduced to 13.3 kPa (which is an absolute pressure; the same applies hereinafter) in 90 minutes since the temperature had reached 210° C. The temperature was kept for 60 more minutes with this pressure maintained.

The phenol vapor produced as a side product as a result of the polymerization reaction was guided to a reflux condenser that used, as a refrigerant, vapor, of which the temperature was controlled at 100° C. as the inlet temperature to the reflux condenser. Small amounts of dihydroxy compounds and diester carbonate included in the phenol vapor were supplied back to the polymerization reactor. Subsequently, the rest of the phenol vapor that had not condensed was guided to, and collected in, a condenser that used hot water at 45° C. as a refrigerant. The content that had been turned into an oligomer in this manner had its pressure raised to the atmospheric pressure once, and then transferred to another polymerization reactor including an impeller and a reflux condenser being controlled in the same way as described above. Then, the temperature started to be raised and the pressure started to be reduced such that the inner temperature would reach 220° C. and the pressure would reach 200 Pa in 60 minutes.

Thereafter, the inner temperature was further raised to 230° C. and the pressure was further reduced to 133 Pa or less in 20 minutes. When a predetermined agitation power was reached, the pressure was allowed to revert to the atmospheric pressure again. Then, the content was removed in the form of a strand, which was then cut out into pellets of the carbonate copolymer with a rotary cutter.

### First to Second Examples and First to Fourth Comparative Examples

Pellets of the carbonate copolymer produced in the first manufacturing example were used, the respective components were mixed together to have the formulation of the thermoplastic resin composition shown in Table 1, and a biaxial extruder with two vent ports (LABOTEX 30HSS-32 manufactured by Japan Steel Works, Ltd.) was used to extrude the resin composition in the form of strands such that the resin would have a temperature of 250° C. at an outlet of the extruder. Next, the resin was water-cooled and solidified, and then pelleted with a rotary cutter. During this process, the vent ports were connected to a vacuum pump and controlled to have a pressure of 500 Pa there. The thermoplastic resin composition thus obtained had its deflection temperature under load (of 1.80 MPa) measured, and the notched Charpy impact strength was evaluated by the methods described above. The results are shown in Table 1.

TABLE 1

| | | | Composition | | Examples | | | Comparative examples | | | |
|---|---|---|---|---|---|---|---|---|---|---|---|
| | | | (mol %) | | 1 | 2 | 3 | 1 | 2 | 3 | 4 |
| Thermoplastic | Component (A) | First | ISB/CHDM = | (mass %) | 90 | 91.5 | 93 | 80 | 95 | 97 | 97 |
| resin | | manufacturing | 70/30 | | | | | | | | |
| composition | | example | | | | | | | | | |
| | Component (B) | M590 | | (mass %) | 10 | 8.5 | 7 | 20 | 5 | 3 | 0 |
| | Component (C) | BHT | | (mass %) | 0.005 | 0.005 | 0.005 | 0.005 | 0.005 | 0.005 | 0.005 |
| | Component (D) | Tinuvin329 | | (mass %) | 0.1 | 0.1 | 0.1 | 0.1 | 0.1 | 0.1 | 0.1 |
| | Component (E) | Tinuvin770DF | | (mass %) | 0.05 | 0.05 | 0.05 | 0.05 | 0.05 | 0.05 | 0.05 |

| | | | | | | | | | |
|---|---|---|---|---|---|---|---|---|---|
| Evaluation | Deflection temperature under load (1.80 MPa) | (° C.) | 97 | 97 | 98 | 94 | 99 | 100 | 102 |
| results | Notched Charpy impact strength | (kJ/m²) | 28 | 25 | 22 | 30 | 16 | 10 | 7 |
| | Comprehensive judgement | | ◯ | ◯ | ◯ | X | X | X | X |

1. An automobile interior/exterior member comprising:
a thermoplastic resin compound containing components (A) to (E),
wherein in the thermoplastic resin compound, the component (A) is 89 to 94 parts by mass, the component (B) is 6 to 11 parts by mass, the component (C) is 0.001 to 0.01 parts by mass, the component (D) is 0.08 to 0.12 parts by mass, and the component (E) is 0.04 to 0.06 parts by mass with respect to 100 parts by mass as a total of the component (A) and the component (B),
the component (A) is polycarbonate resin which has a constitutional unit derived from a dihydroxy compound expressed by the following general formula (1) and a constitutional unit derived from cyclohexane dimethanol and whose content ratio of the constitutional unit derived from the dihydroxy compound expressed by the following general formula (1) and the constitutional unit derived from the cyclohexane dimethanol is 69/31 to 71/29 in units of molar ratio,
the component (B) is butyl acrylate methyl methacrylate styrene-based rubber,
the component (C) is dibutyl hydroxy toluene,
the component (D) is a benzotriazole-based light stabilizer,
the component (E) is a hindered amine-based light stabilizer, and

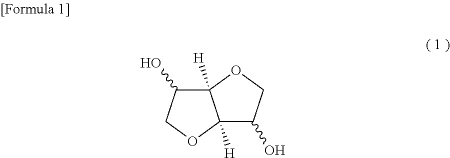

2. The automobile interior/exterior member of claim 1, wherein
the component (E) is a hindered amine-based light stabilizer with a piperidine structure.

3. The automobile interior/exterior member of claim 2, wherein
the component (E) is a hindered amine-based light stabilizer with a plurality of piperidine structures.

4. The automobile interior/exterior member of claim 3, wherein
the plurality of piperidine structures in the hindered amine-based light stabilizer are linked to a single alkane chain by ester binding.

5. The automobile interior/exterior member of claim 1, wherein
the automobile interior/exterior member is obtained by injection molding.

6. The automobile interior/exterior member of claim 2, wherein
the automobile interior/exterior member is obtained by injection molding.

7. The automobile interior/exterior member of claim 3, wherein
the automobile interior/exterior member is obtained by injection molding.

8. The automobile interior/exterior member of claim 4, wherein
the automobile interior/exterior member is obtained by injection molding.
